(19) United States
(12) Patent Application Publication
(10) Pub. No.: US 2026/0121298 A1
(43) Pub. Date: Apr. 30, 2026

(54) ELECTROMAGNETIC WAVE-TRANSMISSIVE LAMINATE AND ELECTROMAGNETIC WAVE RADAR SYSTEM

(71) Applicant: TOYODA GOSEI CO., LTD., Kiyosu-shi (JP)

(72) Inventors: Yuki TATE, Kiyosu-shi (JP); Kozo HIROTANI, Kiyosu-shi (JP); Yuna SUZUKI, Kiyosu-shi (JP); Noriyuki MAEDA, Kiyosu-shi (JP)

(21) Appl. No.: 19/335,075

(22) Filed: Sep. 22, 2025

(30) Foreign Application Priority Data
Oct. 30, 2024 (JP) 2024-190494

(51) Int. Cl. H01Q 15/00; H01Q 1/24

(52) U.S. Cl. CPC H01Q 15/0013; H01Q 1/247

(57) ABSTRACT

A laminate is arranged in front of an electromagnetic wave radar device with respect to a transmission direction of electromagnetic waves. The laminate is electromagnetic wave-transmissive. The laminate includes a base member made of synthetic resin, and a coating film formed on a front surface of the base member. The coating film has a relative permittivity of 3.1 or greater and 40 or less. The thickness of the coating film has a maximum value in an outer peripheral portion of the laminate, and a minimum value in an inner portion of the laminate. The difference of the maximum value and the minimum value is 20 μm or greater and 100 μm or less.

### CROSS-REFERENCE TO RELATED APPLICATIONS

This application is based upon and claims the benefit of priority from Japanese Patent Application No. 2024-190494, filed on October 30, 2024, the entire contents of which are incorporated herein by reference.

### BACKGROUND

### 1. Field

The following description relates to an electromagnetic wave-transmissive laminate and an electromagnetic wave radar system.

### 2. Description of Related Art

JP2024-137120A discloses an electromagnetic wave-transmissive laminate arranged in front of an electromagnetic wave radar device with respect to a traveling direction of electromagnetic waves. The laminate may be a vehicle component, such as an emblem or a front grille, located in front of a millimeter wave radar device mounted on an automobile.

As shown in FIG. 6, a laminate 110 includes a base member 120 made of synthetic resin, and a coating film 140 (color-providing layer) formed on the base member 120.

The coating film 140 provides the external color of an automobile. The coating film 140 contains a filler, and is millimeter wave-transmissive. The coating film is formed by applying a coating material to a front surface of the base member or to a front surface of a primer layer, which may be arranged on the front surface of the base member.

The filler is made of metal, such as aluminum.

As shown in FIG. 6, a coating accumulation 143 may be formed in the outer peripheral portion of the coating film 140 due to the surface tension acting on the applied coating material. In the coating accumulation 143, the coating film 140 has a greater thickness T than other portions. In a case in which the coating film 140 contains a filler as described above, the coating film 140 has a relatively high relative permittivity. Accordingly, the phase of millimeter waves from a millimeter wave radar device may be shifted when passing through the coating accumulation 143. This may adversely affect the position detection accuracy of the millimeter wave radar device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electromagnetic wave-transmissive laminate configured to be arranged in front of an electromagnetic wave radar device with respect to a transmission direction of electromagnetic waves is provided. The laminate includes a base member made of a synthetic resin, and a coating film formed on a front surface of the base member. The coating film has a relative permittivity of 3.1 or greater and 40 or less. A thickness of the coating film has a maximum value in an outer peripheral portion of the laminate, and a minimum value in an inner portion of the laminate. A difference between the maximum value and the minimum value is 20 μm or greater and 100 μm or less.

In another general aspect, an electromagnetic wave radar system is provided. The electromagnetic wave radar system includes an electromagnetic wave radar device, and the above electromagnetic wave-transmissive laminate arranged in front of the electromagnetic wave radar device with respect to the transmission direction of the electromagnetic waves. The laminate includes an electromagnetic wave transmission region in a portion located at an inner side of an edge of the laminate. The electromagnetic wave transmission region overlaps a field of view of the electromagnetic wave radar device. The outer peripheral portion includes a boundary of the electromagnetic wave transmission region.

Other features and aspects will be apparent from the following detailed description, the drawings, and the claims.

### BRIEF DESCRIPTION OF THE DRAWINGS

FIG. 1 is a side view of a laminate and an electromagnetic wave radar device in accordance with an embodiment.

FIG. 2 is a front view of the laminate shown in FIG. 1.

FIG. 3 is a cross-sectional view enlarging portion A shown in FIG. 1.

FIG. 4 is a cross-sectional view taken along line 4-4 shown in FIG. 2.

FIG. 5 is a graph illustrating the relationship between a phase shift of electromagnetic waves when passing through an outer peripheral portion of the laminate and a difference of the maximum thickness and the minimum thickness of a coating film.

FIG. 6 is a cross-sectional view of a typical laminate.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

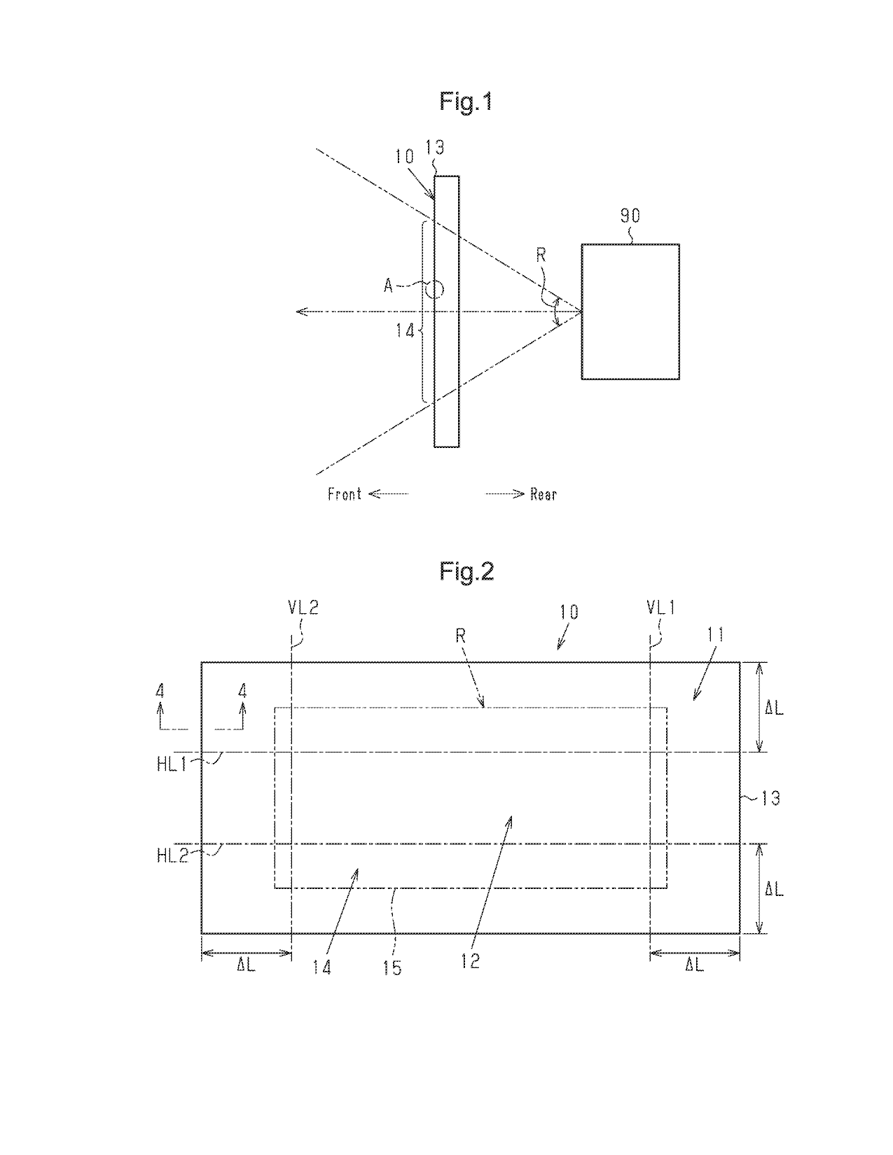

An embodiment of an electromagnetic wave-transmissive laminate and an electromagnetic wave radar system will now be described with reference to FIGS. 1 to 5.

In the present embodiment, the electromagnetic wave radar system is embodied in a millimeter wave radar system mounted on a vehicle, and an electromagnetic wave-transmissive laminate (hereinafter, “laminate”) is embodied in an exterior component for a vehicle.

In the description hereafter, the front side and the rear side of a vehicle with respect to a front-rear direction will be simply referred to as “the front side” and “the rear side”, respectively.

As shown in FIG. 1, an electromagnetic wave radar system includes an electromagnetic wave radar device 90 mounted on a vehicle, and a laminate 10 arranged in front of the electromagnetic wave radar device 90 with respect to a transmission direction of electromagnetic waves.

### Electromagnetic Wave Radar Device 90

As shown in FIG. 1, the electromagnetic wave radar device 90 of the present embodiment is arranged on a front part of the vehicle, and is configured to transmit electromagnetic waves (in the present embodiment, millimeter waves) toward the front side. In the present embodiment, the front side of the vehicle coincides with the front side with respect to the transmission direction of the electromagnetic waves.

### Laminate 10

As shown in FIG. 1, the laminate 10 covers the electromagnetic wave radar device 90 from the front of the electromagnetic wave radar device 90. The laminate 10 is, for example, a cover that forms part of a front shell of the vehicle.

The laminate 10 is electromagnetic wave-transmissive. The laminate 10 of the present embodiment is millimeter wave-transmissive.

As shown in FIG. 2, the laminate 10 of the present embodiment is rectangular from a front view. The laminate 10 does not have to be rectangular. The laminate 10 may be trapezoidal, elliptical, or the like.

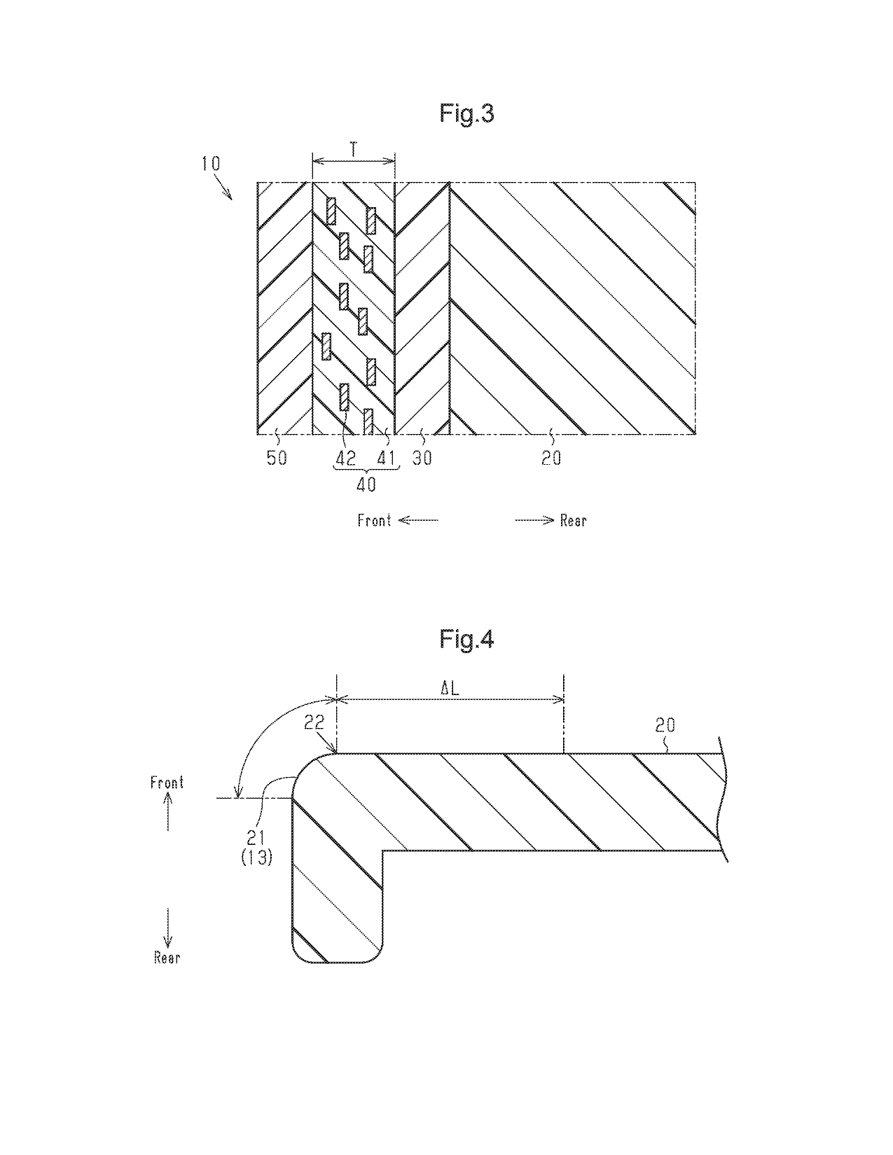

As shown in FIG. 3, the laminate 10 includes a base member 20, a primer layer 30, a coating film 40, and a protection layer 50 in this order from the rear side.

The base member 20 is made of synthetic resin, and is electromagnetic wave-transmissive. The base member 20 of the present embodiment is millimeter wave-transmissive. Examples of the resin material forming the base member 20 include thermoplastic resins, such as polypropylene (PP), polyvinyl chloride (PVC), polymethyl methacrylate (PMMA), acrylonitrile-butadiene-styrene copolymer (ABS), acrylonitrile-ethylene-propylene-diene-styrene (AES), acrylonitrile-styrene-acrylate copolymer (ASA), and polycarbonate (PC). The base member 20 of the present embodiment is made of polycarbonate.

The base member 20 of the present embodiment includes a rounded chamfer 21 on an edge 13 of the front surface of the base member 20 (refer to FIG. 4). The edge 13 defines the contour of the laminate 10 (base member 20) from a front view.

Preferably, the base member 20 has a relative permittivity of 2.5 or greater and 3.0 or less.

The primer layer 30 enhances adhesion between the base member 20 and the coating film 40. The primer layer 30 is formed on the front surface of the base member 20. The primer layer 30 is made of synthetic resin, and is electromagnetic wave-transmissive. The primer layer 30 of the present embodiment is millimeter wave-transmissive. The primer layer 30 may be formed from a known resin coating material used as a primer.

Preferably, the primer layer 30 has a relative permittivity of 3.1 or greater and 38 or less.

The coating film 40 is for providing the external color of the laminate 10. The coating film 40 is formed on the front surface of the primer layer 30. In the present embodiment, the coating film 40 is formed on the front surface of the base member 20 with the primer layer 30 arranged in between.

The coating film 40 is made of synthetic resin, and is electromagnetic wave-transmissive. The coating film 40 of the present embodiment is millimeter wave-transmissive. The coating film 40 is formed by applying a coating material containing a base resin 41 and a filler 42 to the front surface of the primer layer 30.

Examples of a method for applying the coating material include known methods, such as spray coating, dipping, shower coating, flow coating, roll coating, and the like.

The material of the base resin 41 is a resin material included in a known resin coating material. Such a resin material may be, for example, acrylic-based, urethane-based, polyester-based, epoxy-based, melamine-based, alkyd-based, or phenol-based.

The filler 42 may be a material having a higher relative permittivity than the base resin 41. Example of the material for the filler 42 include a lustering material, such as micas, pearl micas, or glass flakes, a metal conductive filler, such as aluminum flakes, a metal oxide conductive filler, such as zinc oxide, and a metal coated conductive filler in which surfaces of micas or glass flakes are coated with a metal, such as aluminum or nickel.

The filler 42 of the present embodiment is aluminum flakes.

The coating film 40 has a relative permittivity of 3.1 or greater and 40 or less. Preferably, the coating film 40 has a relative permittivity of 4.0 or greater and 30 or less.

The protection layer 50 imparts durability to the laminate 10. The protection layer 50 is formed on the front surface of the coating film 40. The protection layer 50 is made of synthetic resin, and is electromagnetic wave-transmissive. The protection layer 50 of the present embodiment is millimeter wave-transmissive. The protection layer 50 is a clear coating layer, and may be formed from a known resin coating material used for clear coating.

The protection layer 50 has a relative permittivity of 2.5 or greater and 3.0 or less.

As shown in FIGS. 1 and 2, the laminate 10 includes an electromagnetic wave transmission region 14 in a portion located at an inner side of the edge 13. The electromagnetic wave transmission region 14 overlaps a field of view (FOV) R of the electromagnetic wave radar device 90.

As shown in FIG. 2, a thickness T of the coating film 40 has a maximum value Tmax in an outer peripheral portion 11 of the laminate 10, and has a minimum value Tmin in an inner portion 12 of the laminate 10.

A difference ΔT of the maximum value Tmax and the minimum value Tmin is 20 μm or greater and 100 μm or less.

The inner portion 12 is located at an inner side of the outer peripheral portion 11 of the laminate 10.

The outer peripheral portion 11 includes a boundary 15 of the electromagnetic wave transmission region 14. The boundary 15 defines the edge of the electromagnetic wave transmission region 14 from a front view.

The thickness T of the coating film 40 may be varied by adjusting the shape of the front surface of the base member 20, conditions for applying the coating material, or the like. For example, when performing spray coating, it is preferred to adjust at least one of spray coating time, spray coating angle, and spraying distance relative to the front surface of the base member 20.

The outer peripheral portion 11 extends inwardly from the edge 13 of the laminate 10 over a predetermined length ΔL. The predetermined length ΔL is, for example, 33 mm.

As shown in FIG. 2, the outer peripheral portion 11 of the present embodiment includes a section between vertical line VL1 and the edge 13 corresponding to the right end of the laminate 10, a section between vertical line VL2 and the edge 13 corresponding to the left end of the laminate 10, a section between horizontal line HL1 and the edge 13 corresponding to the upper end of the laminate 10, and a section between horizontal line HL2 and the edge 13 corresponding to the lower end of the laminate 10.

As shown in FIG. 4, the point from which the predetermined length ΔL extends is located on an inner end 22 of the chamfer 21 of the base member 20, that is, the end of the rounded portion.

As shown in FIG. 2, the inner portion 12 is surrounded by the four lines VL1, VL2, HL1, and HL2 in FIG. 2.

### Operation of the Present Embodiment

The laminate 10 includes the electromagnetic wave transmission region 14 in a portion located at the inner side of the edge 13. The electromagnetic wave transmission region 14 overlaps the field of view R of the electromagnetic wave radar device 90. In the electromagnetic wave transmission region 14, the intensity of electromagnetic waves decreases from the center toward the edge. Accordingly, the position detection performance of the electromagnetic wave radar device 90 is more adversely affected by the thickness T of the coating film 40 in the inner portion 12 of the laminate 10 than that in the outer peripheral portion 11.

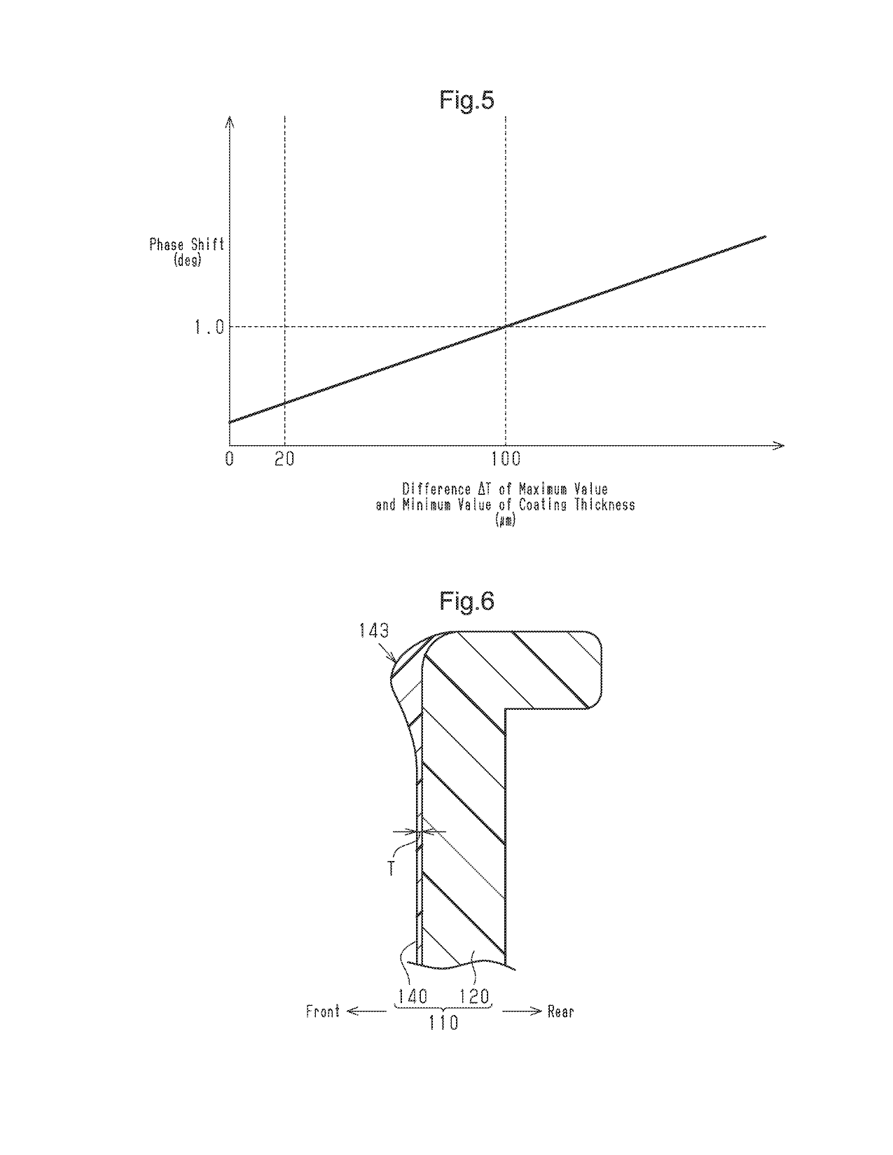

FIG. 5 illustrates the relationship between a phase shift of electromagnetic waves when passing through the outer peripheral portion 11 of the laminate 10 and the difference ΔT of the maximum value Tmax and the minimum value Tmin in the coating film 40 having a relative permittivity of 40.

As the thickness T of the coating film 40 in the outer peripheral portion 11 of the laminate 10 increases relative to the thickness T of the coating film 40 in the inner portion 12, that is, as the difference ΔT between the maximum value Tmax of the thickness T of the coating film 40 and the minimum value Tmin of the thickness T increases, the phase shift of electromagnetic waves passing through the outer peripheral portion 11 becomes greater. If the difference ΔT is unchanged, the phase shift of electromagnetic waves decreases as the relative permittivity of the coating film 40 decreases.

As shown in FIG. 5, in a case in which the coating film 40 has a relative permittivity of 40, the phase shift of electromagnetic waves is 1.0 deg when the difference ΔT is 100 μm. As described above, a coating accumulation is likely to be formed in the outer peripheral portion 11 of the coating film 40. Therefore, it is technically difficult to limit the difference ΔT to less than 20 μm. If the difference ΔT is limited to less than 20 μm by decreasing the thickness of the entire coating film 40, the durability of the coating film 40 may be significantly impaired by an external stress, such as stone chipping or ultraviolet rays. Furthermore, the coating film 40, which contains the filler 42, has a relative permittivity of 3.1 or greater.

With the laminate 10 of the present embodiment, in which the coating film 40 has a relative permittivity of 3.1 or greater and 40 or less, the phase shift of electromagnetic waves passing through the outer peripheral portion 11 of the laminate 10 may be reduced to 1.0 deg or less. In addition, the difference ΔT is 20 μm or greater, thereby ensuring the durability of the coating film 40.

### Advantages of the Present Embodiment

1. The coating film 40 of the laminate 10 has a relative permittivity of 3.1 or greater and 40 or less. The thickness T of the coating film 40 has the maximum value Tmax in the outer peripheral portion 11 of the laminate 10, and has the minimum value Tmin in the inner portion 12 of the laminate 10. The difference ΔT of the maximum value Tmax and the minimum value Tmin is 20 μm or greater and 100 μm or less.

Such a configuration appropriately reduces the phase shift of electromagnetic waves of the electromagnetic wave radar device 90, and increases the degree of freedom for the external color of the laminate 10.

2. The coating film 40 contains the base resin 41 and the filler 42.

The coating film 40 that contains the filler 42, such as aluminum, tends to have a relative permittivity of 3.1 or greater and 40 or less.

In this respect, the above configuration appropriately reduces the phase shift of electromagnetic waves passing through the laminate 10, and increases the degree of freedom for the external color of the laminate 10 with the coating film 40 containing the filler 42.

3. The electromagnetic wave radar system includes the electromagnetic wave radar device 90 and the laminate 10 arranged in front of the electromagnetic wave radar device 90 with respect to the transmission direction of electromagnetic waves. The laminate 10 includes the electromagnetic wave transmission region 14 in a portion located at the inner side of the edge 13 of the laminate 10. The electromagnetic wave transmission region 14 overlaps the field of view R of the electromagnetic wave radar device 90. The outer peripheral portion 11 includes the boundary 15 of the electromagnetic wave transmission region 14.

Such a configuration also obtains advantage (1).

### Modified Examples

The present embodiment may be modified as described below. The present embodiment and the following modifications can be combined as long as they remain technically consistent with each other.

The chamfer 21 on the edge 13 of the front surface of the base member 20 may be omitted. In this case, the point from which the predetermined length ΔL extends may be located on the edge of the front surface of the base member 20.

The primer layer 30 may be omitted as long as the adhesion between the base member 20 and the coating film 40 is sufficient.

The protection layer 50 may be omitted.

The coating film 40 does not have to include the filler 42 as long as the coating film 40 has a relative dielectric constant of 3.1 or greater and 40 or less.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electromagnetic wave-transmissive laminate configured to be arranged in front of an electromagnetic wave radar device with respect to a transmission direction of electromagnetic waves, the laminate comprising:
a base member made of a synthetic resin; and
a coating film formed on a front surface of the base member, wherein
the coating film has a relative permittivity of 3.1 or greater and 40 or less,
a thickness of the coating film has a maximum value in an outer peripheral portion of the laminate, and a minimum value in an inner portion of the laminate, and
a difference between the maximum value and the minimum value is 20 μm or greater and 100 μm or less.

2. The electromagnetic wave-transmissive laminate according to claim 1, wherein the coating film contains a base resin and a filler.

3. An electromagnetic wave radar system, comprising:
an electromagnetic wave radar device; and
the electromagnetic wave-transmissive laminate according to claim 1, arranged in front of the electromagnetic wave radar device with respect to the transmission direction of the electromagnetic waves, wherein
the laminate includes an electromagnetic wave transmission region in a portion located at an inner side of an edge of the laminate, the electromagnetic wave transmission region overlapping a field of view of the electromagnetic wave radar device, and
the outer peripheral portion includes a boundary of the electromagnetic wave transmission region.
